(19) United States
(12) Patent Application Publication
(10) Pub. No.: US 2008/0090044 A1
(43) Pub. Date: Apr. 17, 2008

(54) Ceramic Aggregate Substrate, Ceramic Substrate And Ceramic Aggregate Substrate Fabrication Method

(75) Inventor: Takashi Imamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/721,899

(22) PCT Filed: Dec. 16, 2005
(86) PCT No.: PCT/JP05/23555

§ 371 Date: Jun. 15, 2007

(30) Foreign Application Priority Data
Dec. 17, 2004 (JP) 2004-366490

(51) Int. Cl. B32B 38/00; B32B 3/00

(52) U.S. Cl. 428/43; 156/268

(57) ABSTRACT

When neighboring ceramic substrates are split apart by linear snaps, through-holes and holes with floors, which are formed across the snaps, are also split apart. By splitting apart such a ceramic aggregate substrate along the snaps, it is possible to obtain numerous ceramic substrates, in end faces of which recess portions are formed. In comparison with a case of splitting apart such that throwaway substrates are formed at surroundings of ceramic substrates, a number of the ceramic substrates that are split apart from one ceramic aggregate substrate is larger. Therefore, it is possible to keep a unit cost for each of the ceramic substrates lower.

### BACKGROUND OF THE INVENTION

1. Field of the Invention

The present invention relates to a ceramic aggregate substrate, a ceramic substrate and a ceramic aggregate substrate fabrication method.

2. Description of the Related Art

In recent years, ceramic substrates have sometimes been employed instead of glass-epoxy substrates (see Japanese Patent Application Laid-Open (JP-A) No. 2002-232099).

Such a ceramic substrate is obtained by dividing up a ceramic aggregate substrate, which has been formed by superposing a number of ceramic green sheets and calcining the same. In such a case, a dicing saw or the like is employed to form snaps (grooves) in a surface of the ceramic aggregate substrate. The ceramic aggregate substrate is divided along these snaps, and thus it is possible to obtain a plurality of ceramic substrates.

Now, as shown in FIG. 8, recess portions are sometimes formed in end faces of a ceramic substrate 102. For example, if a component such as a lens barrel or the like is to be installed on the ceramic substrate 102, recess portions 106A, to be used for positioning of such a component, are formed at the end faces of the ceramic substrate 102. Further, if the ceramic substrate 102 is to be covered with a shield member, with a view to shielding electromagnetic waves which are emitted from electronic components and the like mounted on the ceramic substrate 102, recess portions 106B for hooking on the shielding member are formed at the end faces of the ceramic substrate 102.

As shown in FIG. 9, prior to division of a ceramic aggregate substrate 100, these recess portions 106A and 106B are formed beforehand in the form of hole portions 106. Then, when the ceramic aggregate substrate 100 is to be divided up, snaps 108 are formed by a dicing saw or the like at positions corresponding to the end faces of the ceramic substrate 102, and the ceramic aggregate substrate 100 is divided along the snaps 108. Thus, as shown in FIG. 8, the ceramic substrate 102 at which the recess portions 106A and 106B are formed is produced.

However, throwaway substrates 104 are provided around the ceramic substrate 102. Therefore, a number of the ceramic substrates 102 that can be produced from one ceramic aggregate substrate 100 is smaller. As a result, the unit cost for each ceramic substrate 102 is higher, which leads to an increase in costs.

### SUMMARY OF THE INVENTION

An object of the present invention is to eliminate throwaway substrates and obtain more numerous ceramic substrates from a single ceramic aggregate substrate.

A first aspect of the present invention is a ceramic aggregate substrate which is to be split apart into a plurality of ceramic substrates, the ceramic aggregate substrate comprising: a linear cut groove, at which neighboring the ceramic substrates are to be split apart; and a hole portion, which is formed to straddle the cut groove.

With the ceramic aggregate substrate of the first aspect, when adjoining ceramic substrates are split apart by the linear cut grooves, hole portions which are formed across the cut grooves are also split apart. When this ceramic aggregate substrate is split apart along the cut grooves, it is possible to obtain a number of ceramic substrates with recess portions formed in end faces thereof.

Further, in comparison with a case of splitting apart such that throwaway substrates are generated around the ceramic substrates, because the cut grooves are formed such that the ceramic substrates are adjacent, the number of ceramic substrates that can be split apart from a single ceramic aggregate substrate is greater. Therefore, a number of the ceramic aggregate substrates needed to provide a required number of the ceramic substrates can be smaller, and it is possible to keep down transportation costs, storage costs and the like of the ceramic aggregate substrates. Thus, it is possible to lower a unit cost for each ceramic substrate.

Herein, in addition to the recess portions that are required for positioning and the like, unnecessary recess portions are formed at the end faces of the ceramic substrates. However, this is not a problem for product functionality.

In the ceramic aggregate substrate of the first aspect, the hole portion may penetrate through the ceramic aggregate substrate. Alternatively, the hole portion may have a floor.

With the structures described above, through-penetrating holes are formed in the ceramic aggregate substrate. Hence, when the ceramic aggregate substrate is split off at the cut grooves, recess portions in through-penetrating states are formed at the end faces of the ceramic substrate. Alternatively, holes with floors are formed in the ceramic aggregate substrate. Hence, when the ceramic aggregate substrate is split off at the cut grooves, recess portions at which a portion of a surface of the ceramic substrate constitutes a floor are formed at the end faces of the ceramic substrate. Here, such floors may be utilized as reference points for height positioning, in a direction of mounting, of a component that is to be mounted at the ceramic substrate (for example, a lens barrel or the like).

In the ceramic aggregate substrate of the first aspect, the hole portion may be symmetrical with respect to the cut groove. Alternatively, a hole wall face of the hole portion, which hole wall face is to be split apart by the cut groove, may be orthogonal with respect to the cut groove.

With the structures described above, the cut grooves are formed such that the hole portions are symmetrical with respect to the cut grooves. Alternatively, the cut grooves are formed such that hole wall faces of the hole portions that are to be split apart by the cut grooves orthogonally intersect with the cut grooves. Thus, when a cut groove is being formed in the ceramic aggregate substrate, even when a tool for forming the cut groove such as, for example, a blade of a dicing saw, passes through a hole portion, loads acting on the blade are equal in a lateral direction. Thus, because there is no inclination to either left or right with respect to the blade when the blade is passing through the hole portion, it is possible to form the cut groove in a straight linear form.

A second aspect of the present invention is a ceramic substrate on which an electronic component is to be mounted and which is to be installed in electronic equipment, wherein recess portions, which are symmetrical with respect to a center line of the ceramic substrate, are formed at end faces of the ceramic substrate.

For the ceramic substrate of the second aspect, the ceramic substrate is split apart from a ceramic aggregate substrate. At that time, cut grooves for splitting apart neighboring ceramic substrates are formed in the ceramic aggregate substrate with, for example, a dicing saw.

When the recess portions are to be formed in the end faces of the ceramic substrate, the cut grooves are formed so as to run across hole portions. In order to make the recess portions symmetrical with respect to the center lines of the ceramic substrates, the hole portions are formed to be symmetrical with respect to the cut grooves. Hence, when the cut grooves are being formed in the ceramic aggregate substrate, when a blade of a dicing saw is passing through a hole portion, loads acting on the blade are equal in a lateral direction. Thus, the end faces of the ceramic substrate are formed with accurately straight line forms. Moreover, because the recess portions are formed to be in symmetry with respect to the center line, thermal expansion amounts of the ceramic substrate will be balanced with respect to the center line.

A third aspect of the present invention is a ceramic substrate on which an electronic component is to be mounted and which is to be installed in electronic equipment, wherein, at end faces of the ceramic substrate, recess portions are formed at positions which are symmetrical with respect to a center line of the ceramic substrate, the end faces and wall faces of the recess portions orthogonally intersecting.

With the ceramic substrate of the third aspect, when the recess portions are to be formed in the end faces of the ceramic substrate, the hole portions are formed so as to straddle cut grooves. Further, in order to form the recess portions at positions which are symmetrical with respect to the center line of the ceramic substrate, the hole portions are formed to be symmetrical with respect to the center line. Moreover, in order to make wall faces of the recess portions orthogonally intersect with the end faces of the ceramic substrate, the wall faces of the hole portions are formed to orthogonally intersect with the cut grooves. Hence, when the cut grooves are being formed in a ceramic aggregate substrate, when a blade of a dicing saw is passing through a hole portion, loads acting on the blade are equal in a lateral direction. Thus, the end faces of the ceramic substrate are formed with accurately straight line forms.

A fourth aspect of the present invention is a fabrication method of a ceramic aggregate substrate which is to be split apart into a plurality of ceramic substrates, the ceramic aggregate substrate fabrication method comprising: laminating and calcining ceramic sheets, in which a hole portion is formed at a position at which neighboring the ceramic substrates are to be split apart; and after the calcining, forming a linear cut groove for enabling the hole portion to be divided in two and the neighboring ceramic substrates to be split apart.

With the ceramic aggregate substrate fabrication method of the fourth aspect, when the neighboring ceramic substrates are split apart by the cut grooves, because the cut grooves have been formed to run across the hole portions, the hole portions are also divided in half. Thus, recess portions are formed in end faces of the split-apart ceramic substrates.

Because the cut grooves are formed such that the ceramic substrates are adjacent, it is possible to form more numerous ceramic substrates from a single ceramic aggregate substrate without wastage. Therefore, it is possible to fabricate the ceramic substrates with a lower unit cost per substrate.

With the present invention, in the structures described above, it is possible to dispense with throwaway substrates, thus obtaining more numerous ceramic substrates from one ceramic aggregate substrate.

### BRIEF DESCRIPTION OF THE DRAWINGS

FIG. 1 is a perspective view showing a ceramic aggregate substrate relating to an embodiment of the present invention.

FIG. 2 is a partial enlarged view showing the ceramic aggregate substrate relating to the embodiment of the present invention.

FIG. 3 is a view showing a step in fabrication of the ceramic aggregate substrate relating to the embodiment of the present invention.

FIG. 4 is a view showing a step in fabrication of the ceramic aggregate substrate relating to the embodiment of the present invention.

FIG. 5 is a view showing a step in fabrication of the ceramic aggregate substrate relating to the embodiment of the present invention.

FIG. 6 is a view showing a step in fabrication of the ceramic aggregate substrate relating to the embodiment of the present invention.

FIG. 7 is a perspective view showing a ceramic substrate which has been split apart from the ceramic aggregate substrate relating to the embodiment of the present invention.

FIG. 8 is a perspective view showing a ceramic substrate relating to a conventional embodiment.

FIG. 9 is a perspective view showing a ceramic aggregate substrate relating to the conventional embodiment.

### DETAILED DESCRIPTION OF THE INVENTION

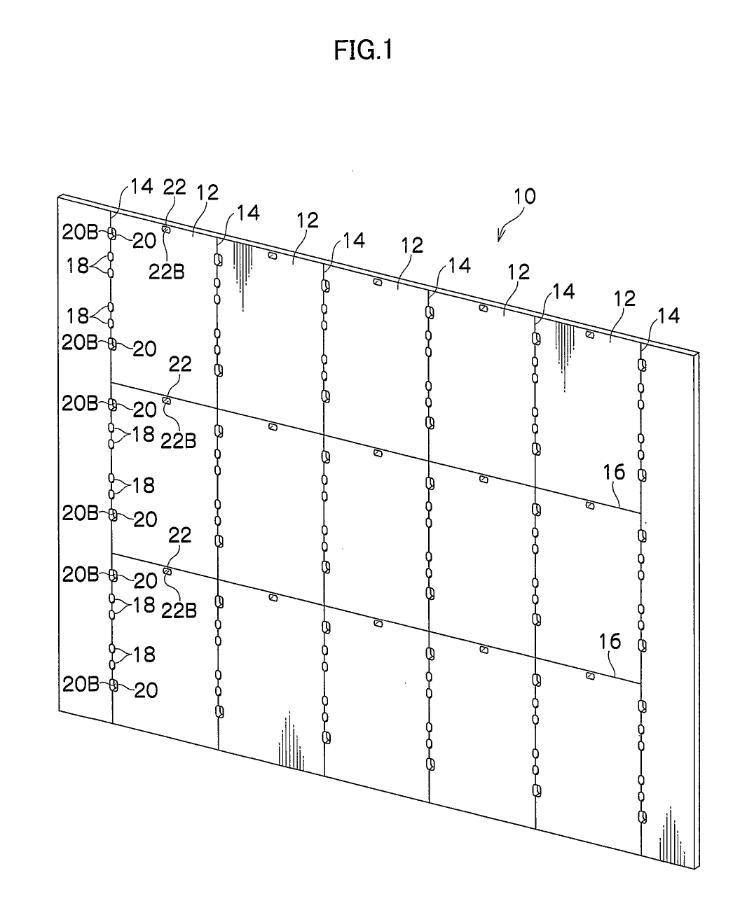

FIG. 1 shows a ceramic aggregate substrate 10 of the present invention.

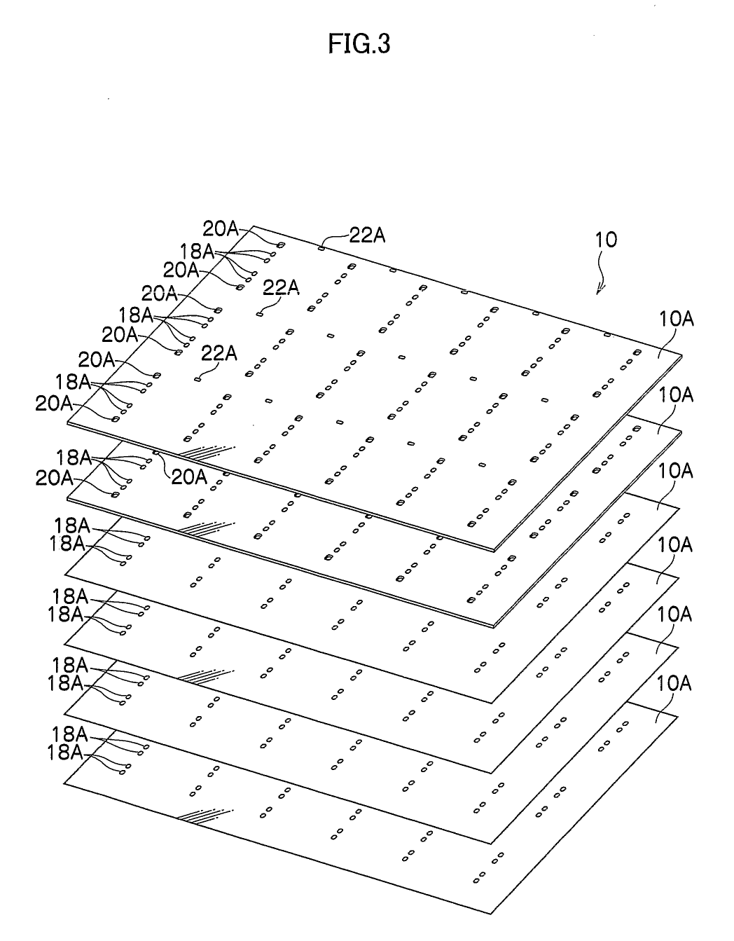

The ceramic aggregate substrate 10 is a structure in which numerous (six in the present embodiment) ceramic green sheets 10A (see FIG. 3) are laminated and calcined. Note that although the present embodiment is structured by laminating six of the ceramic green sheets 10A, the number of the ceramic green sheets 10A to be laminated is not limited to six.

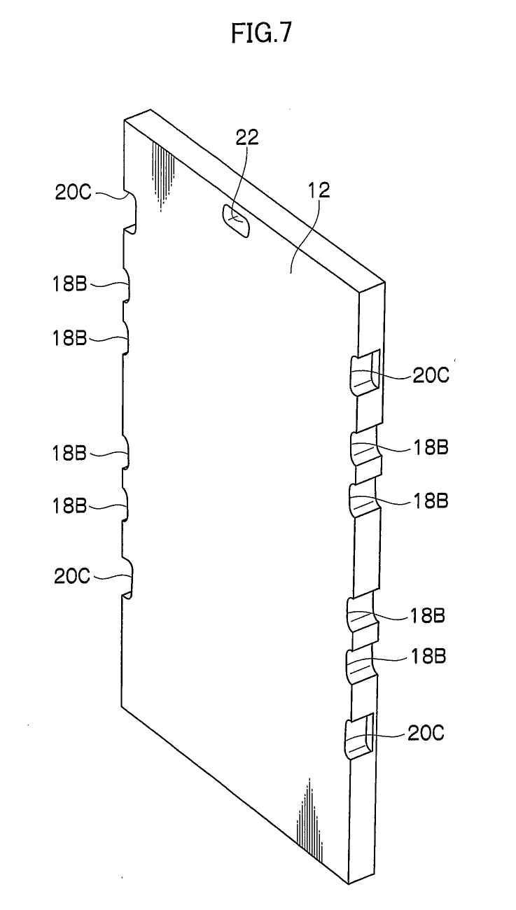

The ceramic aggregate substrate 10 is split apart into a plurality of ceramic substrates 12 (see FIG. 7). For splitting apart neighboring ceramic substrates 12, snaps 14, in a vertical direction of FIG. 1, and snaps 16, in a lateral direction of FIG. 1, are respectively formed in a surface of the ceramic aggregate substrate 10. In addition, pluralities of through-holes 18 and holes with floors 20 are formed in the ceramic aggregate substrate 10 so as to straddle the snaps 14, and holes with floors 22 are formed in the ceramic aggregate substrate 10 at lower sides of the snaps 16.

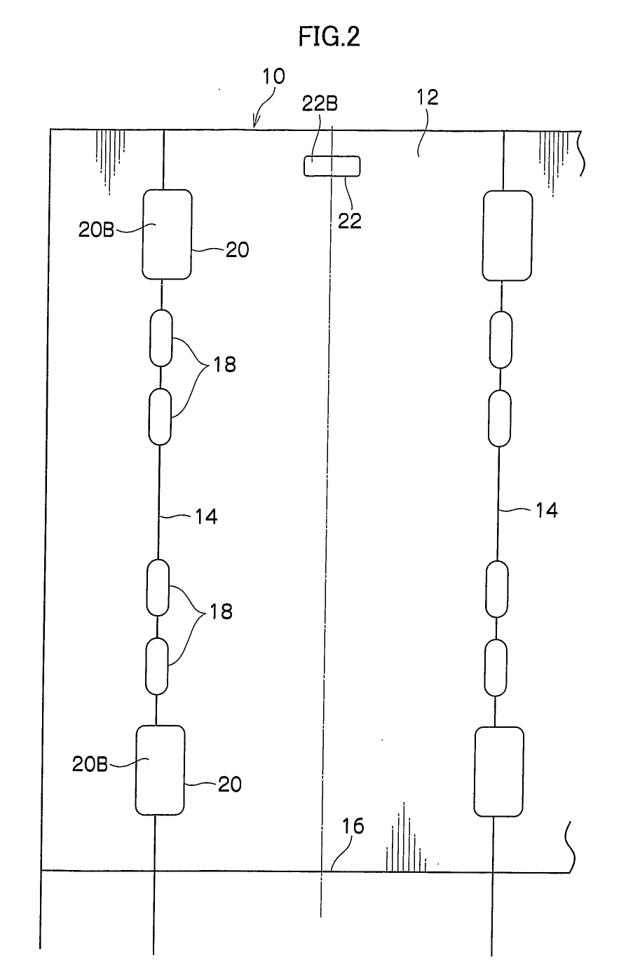

As shown in FIG. 2, the through-holes 18 are formed so as to straddle the snaps 14 formed in the vertical direction of FIG. 2, and are formed as long holes in a plan view. Moreover, the through-holes 18 are formed at positions which are symmetrical with respect to the snaps 14.

The holes with floors 20, similarly to the through-holes 18, are formed to straddle the snaps 14, and are formed as substantially rectangular holes in plan view. Here, while all of corner portions of the holes with floors 20 have curved forms as R shapes, the snaps 14 are formed so as not to cross these corner portions. That is, portions of wall faces of the holes with floors 20 that intersect with the snaps 14 in plan view are formed so as to be perpendicular to the snaps 14.

The holes with floors 22 are formed in substantially rectangular shapes in plan view, so as to be substantially parallel with the snaps 16, which are formed in the lateral direction of FIG. 2, and are formed so as not to straddle the snaps 16.

In the present embodiment, the through-holes 18 are formed as long holes in plan view, but shapes of the through-holes 18 are not limited to long holes. The through-holes 18 may be substantially rectangular shapes in plan view, like the holes with floors 20. In a case in which the through-holes 18 have substantially rectangular shapes, it is sufficient that the snaps 14 orthogonally intersect with wall faces of the through-holes 18; there is no requirement for the through-holes 18 to be symmetrical with respect to the snaps 14.

Moreover, although the holes with floors 20 are formed in substantially rectangular shapes in plan view, shapes of the holes with floors 20 are not limited to substantially rectangular shapes. For example, other shapes are possible, such as, for example, long hole forms. Such a case is satisfactory provided the snaps 14 orthogonally intersect with wall faces of the holes with floors 20 or the holes with floors 20 are symmetrical with respect to the snaps 14.

Further, although the holes with floors 22 are formed in substantially rectangular shapes in plan view. Shapes of the holes with floors 22, such as long hole forms, circles, diamond shapes and so forth, are not particularly limited since the snaps 16 are not structured to run across the holes with floors 22. Further yet, the snaps 16 may be formed so as to cross the holes with floors 22. Such a case is satisfactory provided the snaps 16 orthogonally intersect with wall faces of the holes with floors 22 and/or the holes with floors 22 are symmetrical with respect to the snaps 16.

Next, a fabrication method of the ceramic aggregate substrate 10 and the ceramic substrate 12 will be described.

As shown in FIG. 3, pluralities of through-holes 18A, 20A and 22A are formed by a press or the like in the ceramic green sheets 10A, a principal component of which is a ceramic material such as alumina or the like.

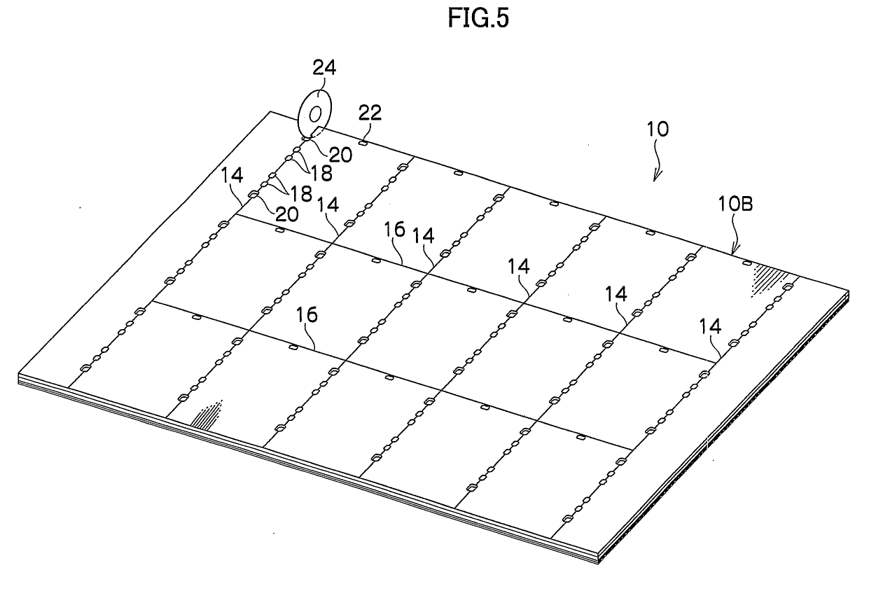

The through-holes 18A and 20A are formed at positions which straddle lines at which the plurality of ceramic substrates 12 will subsequently be divided (see the snaps 14 in FIG. 5). Here, wall faces of the through-holes 18A and 20A are formed so as to orthogonally intersect with the lines of division. In contrast, the through-holes 22A are formed such that wall faces thereof will not cross the lines of division.

At surfaces of these ceramic green sheets 10A, predetermined forms of wiring conductors, conductor patterns which will act as internal wiring conductors, and suchlike (which are not shown) are formed by screen printing.

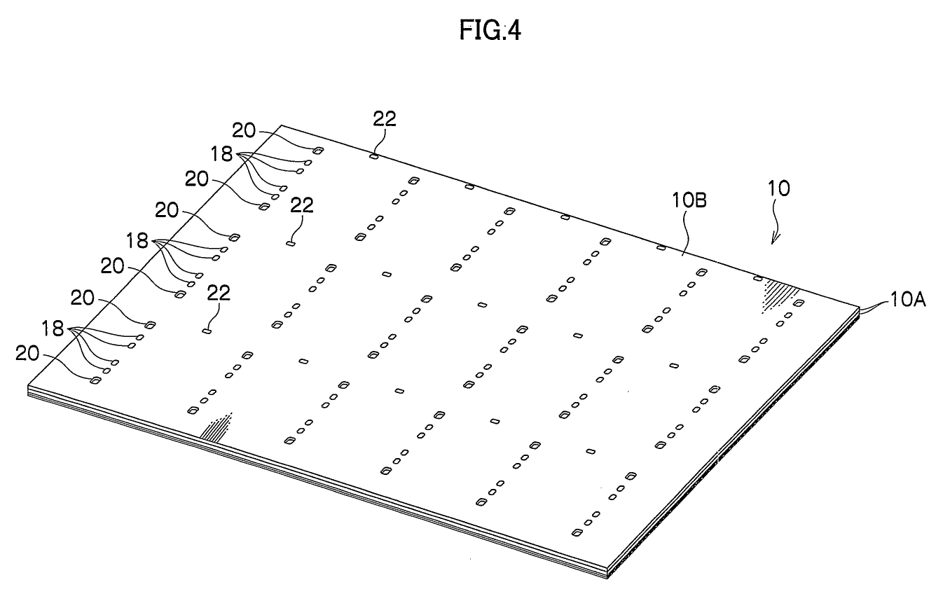

Thereafter, as shown in FIG. 4, the ceramic green sheets 10A are plurally (six in the present embodiment) laminated in a thickness direction, and are provisionally pressed together in the direction of lamination. By laminating the plurality of ceramic green sheets 10A in this manner, a green sheet 10B is formed.

Here, as shown in FIG. 3, the above-mentioned through-holes 20A and 22A are not formed in all of the ceramic green sheets 10A. In the present embodiment, while six layers of the ceramic green sheets 10A are laminated to form the green sheet 10B, the through-holes 20A and 22A are only formed in the top two layers of the ceramic green sheets 10A. That is, the through-holes 20A and 22A are not formed in the lower four layers of the ceramic green sheets 10A. Thus, floor surfaces 20B and 22B are formed (see FIG. 1).

Because the ceramic aggregate substrate 10, which will be discussed below, is formed by laminating the plurality of ceramic green sheets 10A in this manner, the holes with floors 20 and 22 can be formed in the ceramic aggregate substrate 10 with ease.

Next, the green sheet 10B is processed for calcination. A predetermined strength can be provided to the green sheet 10B by this calcination processing. The green sheet 10B which has been subjected to this calcination processing constitutes the ceramic aggregate substrate 10. In accordance with requirements, various layers (an insulation layer, a conduction layer, a resistance layer and a capacitance layer) and the like are formed at a surface of this ceramic aggregate substrate 10, and various electronic components (which are not shown) are mounted thereat.

Then, as shown in FIG. 5, the snaps 14 and 16 for splitting apart the ceramic substrates 12 are formed in a front face and rear face of the ceramic aggregate substrate 10. The snaps 14 and 16 are formed by a dicing saw 24 to predetermined depths (equivalent to two layers of the ceramic green sheets) from the front face and the rear face of the ceramic aggregate substrate 10.

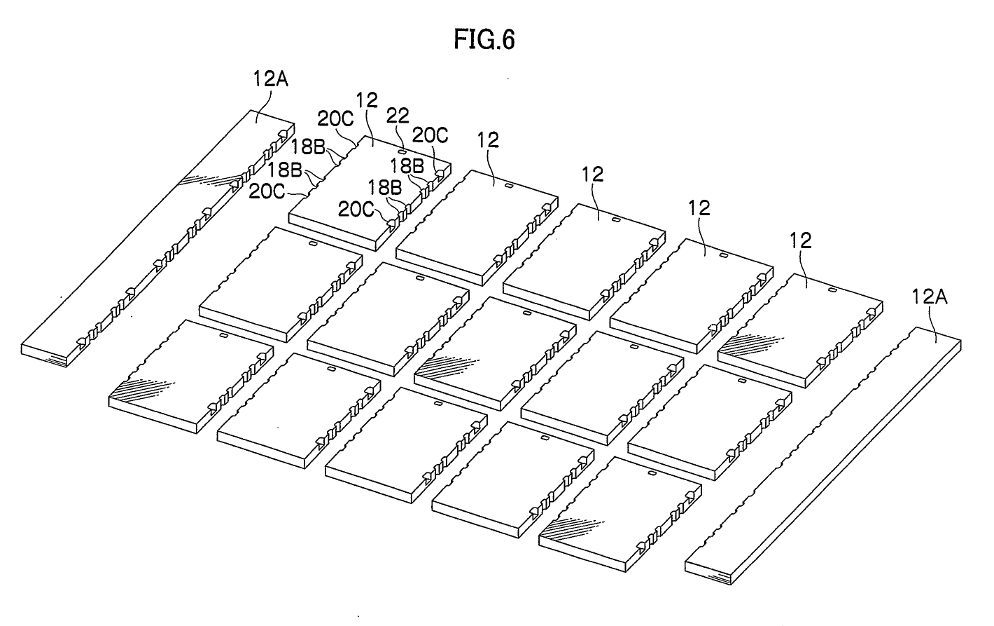

As shown in FIG. 6, the ceramic aggregate substrate 10 in which the snaps 14 and 16 have been formed is divided into the plurality of ceramic substrates 12 by, for example, manually bending the ceramic aggregate substrate 10 or the like to apply pressure from thereoutside. At this time, the through-holes 18 and holes with floors 20 formed in the ceramic aggregate substrate 10 are divided at the same time and, as shown in FIG. 7, the ceramic substrates 12, in end faces of which recess portions 18B and 20C are formed, are obtained.

Here, as shown in FIG. 6, throwaway substrates 12A are formed at two end portions of the ceramic aggregate substrate 10.

Next, operation of the present embodiment of the invention will be described.

As shown in FIG. 1, when the adjoining ceramic substrates 12 are split apart by the straight line-form snaps 14 and 16, the through-holes 18 and holes with floors 20 which are formed to straddle the snaps 14 also split apart. A number of the ceramic substrates 12, in whose end faces the recess portions 18B and 20C are formed (see FIGS. 6 and 7), can be obtained by this splitting apart of the ceramic aggregate substrate 10 along the snaps 14 and 16.

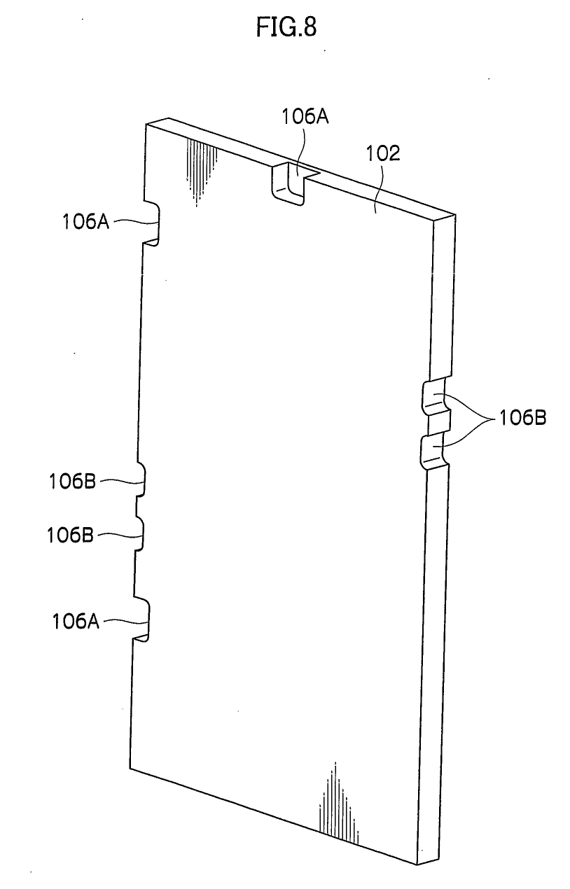

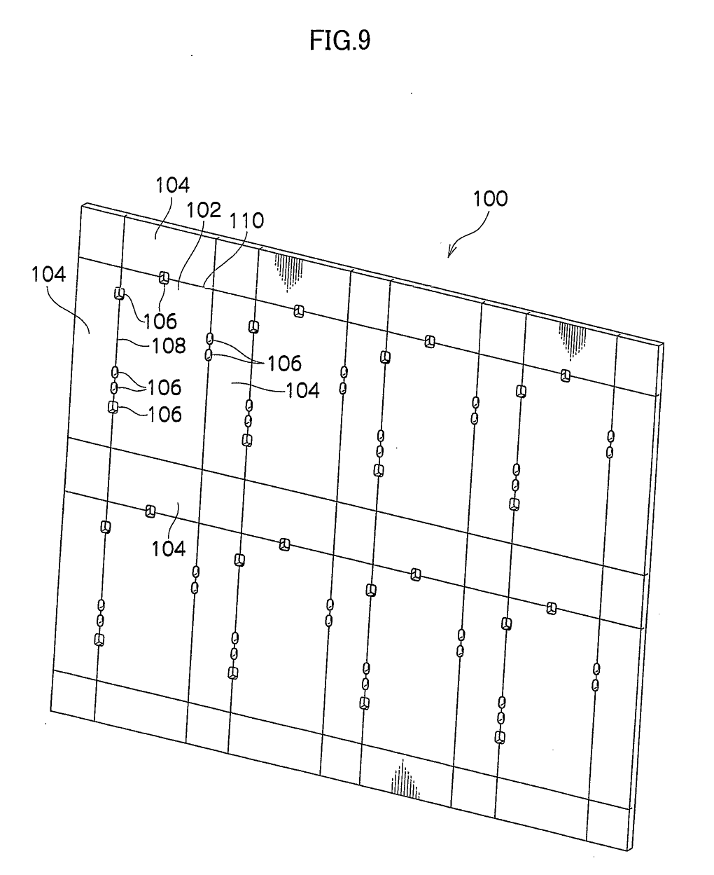

In the case of the ceramic aggregate substrate 10, as shown in FIG. 1, the snaps 14 and 16 are formed such that the ceramic substrates 12 are adjacent. Therefore, a number of ceramic substrates 12 that are separated from one of the ceramic aggregate substrate 10 is greater than in the case of splitting apart such that the throwaway substrates 104 are generated around the ceramic substrate 102 as shown in FIGS. 8 and 9. Correspondingly, a number of the ceramic aggregate substrate 10 that are needed to provide a required number of the ceramic substrates 12 can be smaller, and it is possible to keep down material costs, transportation costs, storage costs and the like of the ceramic aggregate substrates 10. Thus, it is possible to lower a unit cost for each of the ceramic substrates 12.

Herein, in addition to recess portions at the end faces of the ceramic substrates 12 that are required for, for example, positioning of a lens barrel or the like which is a component to be mounted at the ceramic substrate 12, anchoring of a shield case or the like which shields electromagnetic waves emitted from electronic components mounted at the ceramic substrate 12, and the like, unnecessary recess portions are formed. However, this is not a problem for product functionality.

Further, because the snaps 14 are formed such that the through-holes 18 and holes with floors 20 are symmetrical with respect to the snaps 14 and/or such that the snaps 14 orthogonally intersect wall faces of the through-holes 18 and holes with floors 20, when the snaps 14 are being formed in the ceramic aggregate substrate 10, even when a tool for forming the snaps 14 such as, for example, a blade of a dicing saw, passes through the through-holes 18 and the holes with floors 20, loads acting on the blade are equal in a lateral direction. Thus, because there is no inclination to either left or right with respect to the blade when the blade is passing through the through-holes 18 and holes with floors 20, it is possible to form the snaps 14 with straight linear forms.

In the present embodiment, electronic components are mounted in a state of the ceramic aggregate substrate 10 of a step prior to splitting apart the ceramic substrates 12. Therefore, in comparison with a case of mounting electronic components after splitting apart the ceramic substrates 12, a number of substrates at which electronic components are to be mounted is greatly reduced. Consequently, an amount of time for mounting the electronic components is shortened. This further enables reduction to a lower unit cost for each of the ceramic substrates 12.

Further yet, because the holes with floors 20 (the recess portions 20C) and the holes with floors 22 are portions at which through-penetration is not required, a larger area can be reserved for mounting of electronic components at the surface (a rear face) of a side of the ceramic substrate 12 at which the recess portions 20C and the holes with floors 22 are not formed. Herein, when, for example, a component such as a lens barrel or the like is to be mounted at the ceramic substrate 12, the recess portions 20C and hole with floor 22 formed in the ceramic substrate 12 can be utilized as reference points for determining height in a mounting direction.

1. A ceramic aggregate substrate which is to be split apart into a plurality of ceramic substrates, the ceramic aggregate substrate comprising:
a linear cut groove, at which neighboring the ceramic substrates are to be split apart; and
a hole portion, which is formed to straddle the cut groove.

2. The ceramic aggregate substrate of claim 1, wherein the hole portion penetrates through the ceramic aggregate substrate.

3. The ceramic aggregate substrate of claim 1, wherein the hole portion includes a floor.

4. The ceramic aggregate substrate of claim 1, wherein the hole portion is symmetrical with respect to the cut groove.

5. The ceramic aggregate substrate of claim 1, wherein a hole wall face of the hole portion, which hole wall face is to be split apart by the cut groove, is orthogonal with respect to the cut groove.

6. The ceramic aggregate substrate of claim 1, wherein a plurality of the hole portion are formed in symmetry with respect to a center line of one of the ceramic substrates.

7. The ceramic aggregate substrate of claim 1, wherein ceramic sheets in which hole portions are formed are laminated and calcined for forming the ceramic aggregate substrate, the hole portions of the respective ceramic sheets penetrating through the ceramic aggregate substrate.

8. The ceramic aggregate substrate of claim 1, wherein ceramic sheets are laminated and calcined for forming the ceramic aggregate substrate, a hole portion which is formed in at least a topmost of the ceramic sheets not penetrating through the ceramic aggregate substrate.

9. A ceramic substrate on which an electronic component is to be mounted and which is to be installed in electronic equipment, wherein recess portions, which are symmetrical with respect to a center line of the ceramic substrate, are formed at end faces of the ceramic substrate.

10. The ceramic substrate of claim 9, wherein the recess portion penetrates through the ceramic substrate.

11. The ceramic substrate of claim 9, wherein the recess portion includes a floor in a thickness direction of the ceramic substrate.

12. A ceramic substrate on which an electronic component is to be mounted and which is to be installed in electronic equipment, wherein, at end faces of the ceramic substrate, recess portions are formed at positions which are symmetrical with respect to a center line of the ceramic substrate, the end faces and wall faces of the recess portions orthogonally intersecting.

13. A fabrication method of a ceramic aggregate substrate which is to be split apart into a plurality of ceramic substrates, the ceramic aggregate substrate fabrication method comprising:
laminating and calcining ceramic sheets, in which a hole portion is formed at a position at which neighboring the ceramic substrates are to be split apart; and
after the calcining, forming a linear cut groove for enabling the hole portion to be divided in two and the neighboring ceramic substrates to be split apart.

14. The ceramic aggregate substrate fabrication method of claim 13, wherein the hole portion penetrates through the ceramic aggregate substrate.

15. The ceramic aggregate substrate fabrication method of claim 13, wherein the hole portion includes a floor.

16. The ceramic aggregate substrate fabrication method of claim 13, wherein the hole portion is symmetrical with respect to the cut groove.

17. The ceramic aggregate substrate fabrication method of claim 13, wherein a hole wall face of the hole portion, which hole wall face is to be split apart by the cut groove, is orthogonal with respect to the cut groove.

18. The ceramic aggregate substrate fabrication method of claim 13, wherein hole portions are formed in symmetry with respect to center lines of the ceramic substrates that are split apart.
